(19) United States
(12) Patent Application Publication
(10) Pub. No.: US 2002/0080781 A1
(43) Pub. Date: Jun. 27, 2002

(54) Method and arrangement relating to data transmission

(75) Inventor: Morgan Gustavsson, Boras (SE)

Correspondence Address: BURNS DOANE SWECKER & MATHIS L L P, POST OFFICE BOX 1404, ALEXANDRIA, VA, 22313-1404, US

(73) Assignee: Telefonaktiebolaget LM Ericsson (publ), STOCKHOLM (SE)

(21) Appl. No.: 10/024,006

(22) Filed: Dec. 21, 2001

(30) Foreign Application Priority Data
Dec. 21, 2000 (SE) 0004804-1

(51) Int. Cl. H04Q 11/00; H04L 12/50

(52) U.S. Cl. 370/359

(57) ABSTRACT

The present invention relates to an arrangement for data transmission in an expandable modular system (200, 400), preferably for point-to-multipoint transmission, formed of a plurality of structurally and electrically connectable modules (210a-210c, 410a-410b), between each module being located databus connectors (220, 420, 225, 425), which under operation allow connection and disconnection of the modules, each databus connector being connected to a driver (250) and a receiver (260) arrangement, each comprising output and input channels, said outputs being connected to said inputs. Thus for each module said arrangement comprises a signal termination arrangement (270, 270′, 270″, 270′″) arranged outside said driver and receiver between said output channels of the driver arrangement (250) and the input channels of the receiver arrangement (260).

### TECHNICAL FIELD OF THE INVENTION

The present invention relates to a method and arrangement in expandable modules, such as backplanes, PCBs, etc. More specially, the present invention relates to an arrangement for data transmission in an expandable modular system formed of a plurality of structurally and electrically connectable modules. Between each module being located databus connectors, which allow connection and disconnection of the modules, each databus connector being connected to a driver and receiver arrangement, each comprising interconnected output and input channels, respectively.

### BACKGROUND OF THE INVENTION

When arranging, for example microwave radio systems (e.g. MINI-LINK™) in communications networks, there is a need for the constructor of the network to be able to acquire exactly what is needed without consideration for the future expansions of the system.

Presently, the constructor of the network has access to a rack provided with a number of fixed spaces for different modules. However, an expandable and flexible system is required which is not limited to a fixed number of slots in a rack.

In case of microwave radio systems, the data bit rate travelling through the system is high. The data and other connections between the different modules are connected through the backplane of each module. In an expandable, modular system the number of modules to be connected is initially unknown. In a system with fixed number of modules it is not a problem as the backplane when manufactured can be adapted to the number of modules and desired bit rate. However, this cannot be foreseen in an expandable system.

Moreover, the system besides being robust must among others be able to handle.

hot-swap of modules (such as removal and insertion of controller cards) and backplanes without bit error,

hot expansion, i.e. adding modules under operation,

avoiding termination of signals at each end, which requires hardware or software control,

a large number of connections,

signal mismatch and reflection elimination, and

Point-to-Multipoint configurations.

The same problem may occur in other systems for transmitting data with high bit rates with a need for further expansions, such as inter-connectable controller cards etc.

There are known techniques for transmission of high bit rates. In single-ended mode, for example, bit rates up to for example 34 Mbit can be transmitted in a short range (10 cm) without need for termination. It is also possible to manage hot-swap and dead state for non-active sections in the signal path. The benefits of this technique are: many suppliers can deliver the systems with same performance, it is single wired, it is simple and straightforward and it allows optimising signal quality by means of termination. However, the technique has some major drawbacks: it requires high voltage with considerable Electromagnetic Interference (EMI), reduction of the signal amplitude due to the termination, short range and small interference margins.

Another known technique is Differential Mode. This technique is well known, can be used for very high bit rates, it has good interference margins and low voltage oscillation allows low EMI. However, this technique requires signal termination, it is expensive and can only be used in applications with fixed number of modules.

Reflections are usually caused by mismatched impedances, i.e. changes of impedance along the line, among others caused by incorrect termination values. If the backplane is part of a transmission line, the use of termination is usually required. When the signal travels down the backplane and encounters matched termination R_{T}=Z, no reflection occurs. This is assumed to be the best case for signal quality. A non-matched termination to the backplane's loaded impedance, will result in reflections and degradation of the signal quality.

Fully loaded, single-ended backplanes typically have a Z_{L} value of around 30Ω to 45Ω as their AC (loaded) impedance. For the matched case, the termination resistor value is equal to Z_{L,} and the resistors are located at both ends of the backplane.

The DC level is reduced with two terminations due to the driver operating with a larger sink current. When low-impedance (30Ω) termination resistors have been selected, we also must consider the resulting amount of load current that the backplane ICs will have to sink (per channel). The worst case occurs is when driving a backplane with 30Ω loaded impedance and a signal with a 3V swing. This will require 200 mA of load current, but if the signal swing is reduced to 1V, the current required decreases to only 67 mA.

Most TTL backplane ICs do not have the required current drive to pull the signal out of their wide threshold area; therefore, they must rely on reflections to change state. The loaded bus impedance is the reason backplane drivers are required to sink large currents. This must be done while maintaining their load voltage ratings to maintain noise margins.

FIG. 1 is a schematic wiring diagram, showing a differential mode backplane 100 comprising a fixed number of module slots Sₗ . . . Sₙ, a so-called Multi-Point bus configuration. A plug-in control card or the like can be inserted in each slot. For each slot is arranged an input-driver 150 and a receiver 160. The common termination is achieved by means of resistance 170 and 180 between the output channels of the drivers and input channels of the receivers. Each resistance is about 100Ω.

U.S. Pat. No. 4,790,762 discloses a modular programmable controller having an expandable backplane formed of a plurality of structurally and electrically connectable backplane units, each comprising a housing having at least a pair of side walls, corresponding edges of which define a seating surface against which an input/output module may be secured. Between the sidewalls are located field wiring and control bus connectors, which allow plug-in and removal of a module without disturbing the field wiring or control bus. The control bus segment in a backplane unit comprises an edge card receiving connector in one sidewall connected to a card with conductors protruding from the other sidewall, the card also being connected to a control bus connector for the module.

DE 198 06 601 a high speed back plane connects each circuit board in parallel with the other circuit boards in the system. The boards are connected together via at least one common signal line with plug connectors, which are subjected to a digital data transfer rate. For a data transfer rate whose physical data frequency is greater than 10 Mhz, the impedance of the signal lines in the bus board with plug connectors is less than 30 Ohms.

U.S. Pat. No. 5,827,074 relates to a backplane system provides a terminator assembly that mounts along an axis that is parallel to a plane of the backplane. The backplane system has modular backplanes connected to a removable terminator assembly. Connectors coupled the backplanes to the terminator assembly and each other. This document only concerns arranging a termination for mounted modules. It does not allow hot-swap, consider point-to-multipoint transmissions, impedance regulation, signal mismatch or reflections.

According to EP 488 057, a backplane, provides a physical layer level interconnection between a plurality of modules. The backplane includes a physical layer implementation of an interconnection topology incorporated within one or more integrated circuits called interconnect chips. Incorporated on the interconnect chips are interconnect drivers and interconnect receivers for the physical layer implementation of the interconnection topology. These interconnect drivers and interconnect receivers provide point-to-point links between the physical layer implementation of the interconnection topology and the plurality of modules. Each point-to-point link may include two separate point-to-point link lines, one for an interconnect driver and one for an interconnect receiver. For the bus interconnection topology, alternately, each point-to-point link may be tri-level, including only a single point-to-point link line. The interconnection topology may be, for example, a bus topology, a ring topology or a circuit switched topology, In each driver and receiver circuit, a resistor is arranged for matching the point-to-point line impedance. This solution provides a non-flexible and limited solution. It does not allow hot-swap, consider point-to-multipoint transmissions, signal mismatch or reflections.

### SUMMARY OF THE INVENTION

The main object of the present invention is to provide an expandable and flexible modular data transferring system, which solves the above-mentioned problems related with known techniques, and allows connection of an arbitrary number of modules without a need for a common end termination of the data signals. Preferably, the modular system is stackable. The arrangement according to the invention allows hot-swaps, a large number of connections, signal mismatch and reflection elimination, and Point-to-Multipoint configurations, in a simple but yet competent way.

Therefore, the initially described arrangement for each module comprises a signal termination arrangement arranged between said output channels of the driver arrangement and the input channels of the receiver arrangement. The interconnection is achieved by connecting output channels of said driver arrangement to corresponding output channels of another driver arrangement of another module. In the most preferred embodiment, the signal termination arrangement comprises an impedance load. The system is flexible, and the termination arrangement is arranged directly between the output channels of the driver arrangement and/or the input channels of the receiver arrangement.

Preferably, the module is a carrier for electronic components, such as a backplane.

The invention is most suited for data transmission is high bit rate transmission.

The invention also relates to a backplane unit, for structurally and electrically interconnection to a second backplane unit, between each backplane unit being located wiring and databus connectors, which allow plug-in and removal of a module, each databus connector being connected to a driver and a receiver arrangement, each comprising output and input channels, said outputs being connected to said inputs. Hence, between said output channels of the driver arrangement and the input channels of the receiver arrangement a signal termination arrangement is arranged. The termination arrangement is arranged directly between the output channels of the driver arrangement and/or the input channels of the receiver arrangement. The output channels of said driver arrangement are connected to corresponding output channels of another driver arrangement through said backplane unit. Preferably, backplane unit is arranged in a high bit rate transmission system.

The invention also relates to a method of terminating signals travelling in a databus, in an arrangement for data transmission in an expandable modular system formed of a plurality of structurally and electrically connectable module, between each module being located databus connectors, which allow connection and disconnection of the modules, each databus connector being connected to a driver and a receiver arrangement, each comprising output and input channels, said outputs being connected to said inputs. The method comprises the step of arranging each module with a signal termination arrangement between said output channels of the driver arrangement and the input channels of the receiver arrangement.

### BRIEF DESCRIPTION OF THE DRAWINGS

In the following, the invention will be further described in a non-limiting way with reference to the accompanying drawings in which:

FIG. 1 is a schematic wiring diagram of a backplane according to prior art,

FIG. 2 is a schematic cross-sectional view of a first embodiment comprising backplanes, according to the invention,

FIG. 3 illustrates a schematic wiring diagram of a system according to the invention, and

FIG. 4 is a schematic side view of a second embodiment comprising printed circuit boards, according to the invention,

### DETAILED DESCRIPTION OF THE EMBODIMENTS

In the following, the present invention will be described in conjunction with non-limiting embodiments relating to backplanes and printed circuit boards (PCBs). However, the teachings of the invention can be applied to any system in which data transmission and expansion are needed.

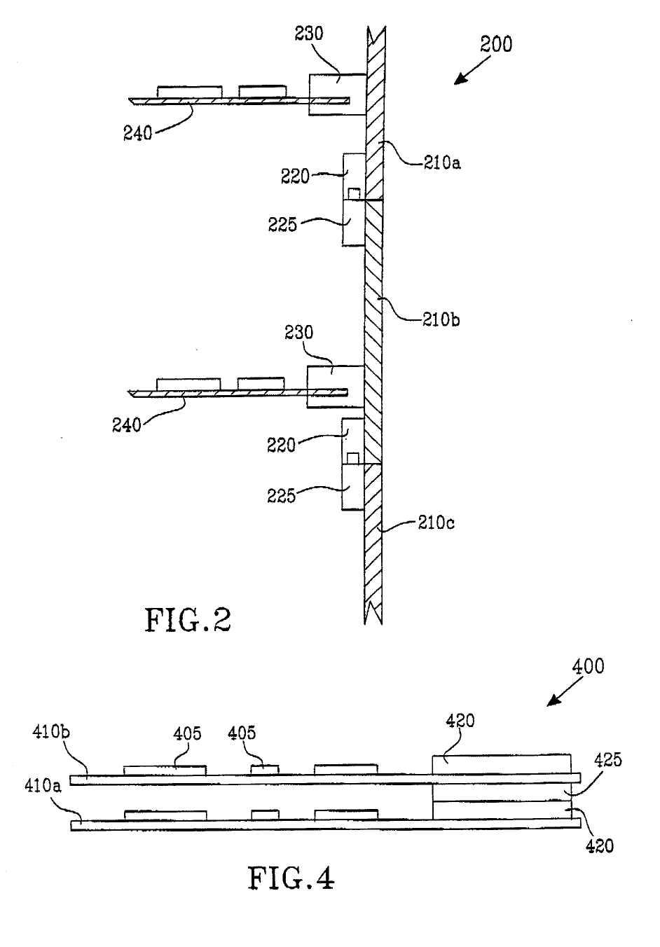

The structure of an expandable backplane arrangement 200 is shown in a schematic way in FIG. 2 formed of a plurality of structurally and electrically connectable backplane units 210a-210b, three of which are shown for simplicity reasons. Between each backplane unit 210, wiring and databus connectors 220 and 225 are provided, which allow plug-in and removal of a module at least at one end of a backplane without disturbing the wiring or databus. The wiring and databus segments in each backplane unit comprise a first 220 and a second connector 225, which connect to a second 225 and first connector 220, respectively, of the preceding or succeeding unit. Each backplane unit 210 comprises a connector 230 for connecting an external unit 240 such as a controller card, traffic generator card or the like.

In another embodiment as shown in FIG. 4, the invention can be applied to a stackable (or in other way in series connectable) PCB assembly 400 comprising inter-connectable PCBs 410a and 410b. Each PCB is arranged to carry components 405 at least on one side. The PCBs are connected by means of connectors 420 and 425.

The wiring diagram of a backplane provided with an arrangement according to the present invention is schematically illustrated in FIG. 3 (also applicable to PCB case). For each backplane unit 210 is provided a driver 250 and a receiver 260. Although, five backplane units are illustrated, it is obvious that the number of backplane units is optional and not limited by any means, which is the advantage of the present invention. The drivers and receivers are of conventional type, such as bus LVDS ( Low-Voltage Differential Signalling) devices. The drivers and receivers can be arranged on the module 240 or on the backplane. However, due to the requirements on short signal distances, it is preferred that the drivers/receivers are arranged on the module 240. In case of the PCB stack of FIG. 4, the drivers and receivers (usually provided in one circuit package) are arranged directly on the PCB.

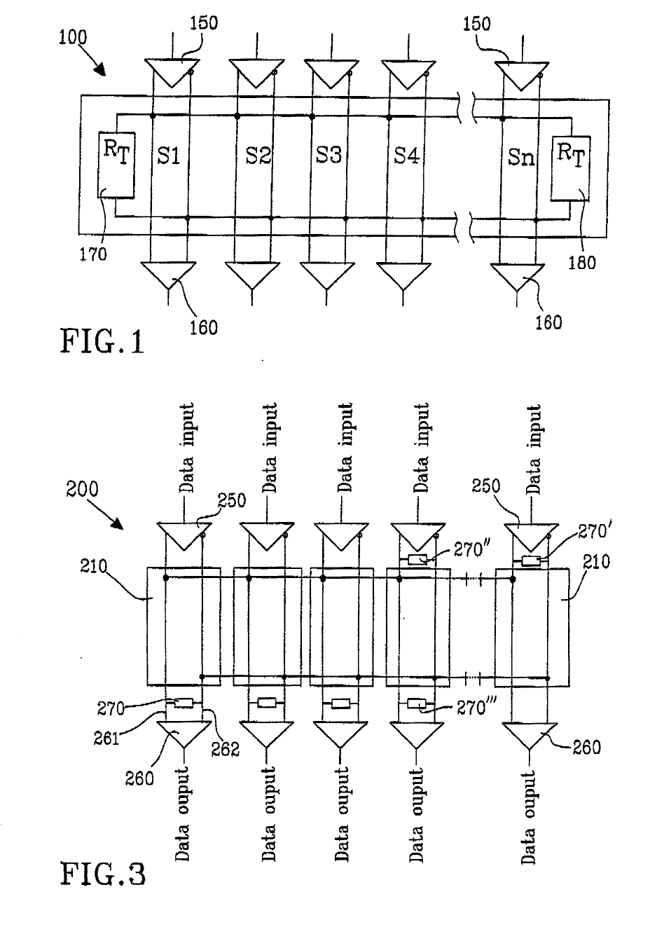

In contrast to the fixed differential mode application shown in FIG. 1, the data busses are not end-terminated. Each receiver 260 is provided with an external resistance (R_{T}) 270 (i.e. outside the circuit) between its input channels 261 and 262, which reduces reflections. Moreover, the output channels of each driver are interconnected, in this case over the backplanes (when at least two backplanes are connected). The advantage of this configuration is that the need for termination, which must be connected in and out (mechanically, electrically or through software control) is eliminated. In case of inter-connected PCBs the connection between the output channels can be achieved through the inter-connecting connectors. The result is that the impedances are distributed along the signal path. When a module is inserted or removed, some insignificant disturbance in the impedance of the modules may occur. However, through dimensioning of the terminations, this disturbance will not affect the overall impedance.

Furthermore, it is also possible to arrange the termination 270′ (externally) at the output channels of the drivers or both at the output of the driver or input of the receiver 270″ and 270′″, as shown in the right-hand side of FIG. 3. In these cases, the termination must be arranged physically close to the input channels.

For dimensioning the impedances, it is possible to start from a fixed backplane, for example having R_{T}=100Ω, which gives 100//100Ω=50Ω. For a backplane intended for five backplane units, the R_{T} of each receiver will be 5*50Ω=250Ω, which can be approximated to 220Ω (a fixed standard value).

The invention is not limited to the shown embodiments but can be varied in a number of ways without departing from the scope of the appended claims and the arrangement and the method can be implemented in various ways depending on application, functional units, needs and requirements etc.

What we claim is:

1. An arrangement for data transmission in an expandable modular system, preferably for point-to-multipoint transmission, formed of a plurality of structurally and electrically connectable modules, between each module being located databus connectors, which under operation allow connection and disconnection of the modules, each databus connector being connected to a driver and a receiver arrangement, each comprising output and input channels, said outputs being connected to said inputs, wherein for each module said arrangement comprises a signal termination arrangement arranged outside said driver and receiver between said output channels of the driver arrangement and the input channels of the receiver arrangement.

2. The arrangement according to claim 1, wherein said output channels of said driver arrangement are connectable to corresponding output channels of another driver arrangement of another module.

3. The arrangement according to claim l, wherein said signal termination arrangement comprises an impedance load.

4. The arrangement according to claim 1, wherein said termination arrangement is arranged directly between the output channels of the driver arrangement and/or the input channels of the receiver arrangement.

5. The arrangement according to claim 1, wherein said module is a carrier for electronic components (410a, 410b).

6. The arrangement according to claim 1, wherein said module is a backplane.

7. The arrangement according to claim 1, wherein said data transmission is high bit rate transmission.

8. A backplane unit, preferably for point-to-multipoint transmission, for structurally and electrically interconnection to a second backplane unit, between each backplane unit being located wiring and databus connectors, which allow plug-in and removal of a module, preferably under operation, each databus connector being connected to a driver and a receiver arrangement, each comprising output and input channels, said outputs being connected to said inputs, wherein between said output channels of the driver arrangement and the input channels of the receiver arrangement and outside said driver and receiver arrangements, a signal termination arrangement is arranged.

9. The backplane unit according to claim 8, wherein said termination arrangement is arranged directly between the output channels of the driver arrangement and/or the input channels of the receiver arrangement.

10. The backplane unit according to claim 8, wherein said output channels of said driver arrangement are connected to corresponding output channels of another driver arrangement through said backplane unit.

11. The backplane unit according claim 8, wherein said backplane unit is arranged in a high bit rate transmission system.

12. A method for terminating signals and preferably reducing signal reflections in an arrangement for data transmission in an expandable modular system, preferably for point-to-multipoint transmission, formed of a plurality of structurally and electrically connectable modules, between each module being located databus connectors, which under operation allow connection and disconnection of the modules, each databus connector being connected to a driver and a receiver arrangement, each comprising output and input channels, said outputs being connected to said inputs, the method comprising arranging for each module a signal termination arrangement outside said driver and receiver between said output channels of the driver arrangement and the input channels of the receiver arrangement.
